(19) United States
(12) Patent Application Publication
(10) Pub. No.: US 2009/0164454 A1
(43) Pub. Date: Jun. 25, 2009

(54) SYSTEM AND METHOD FOR SEARCHING VENUES BASED ON SIMILARITY VALUES

(76) Inventors: Thomas V. Sanguinetti, La Jolla, CA (US); Dave T. Sanguinetti, La Jolla, CA (US); David T. Martin, La Jolla, CA (US)

Correspondence Address: Michael A. Rahman, 5664 Mallard Trace, Frisco, TX, 75034, US

(21) Appl. No.: 11/963,667

(22) Filed: Dec. 21, 2007

(51) Int. Cl. G06F 17/30

(52) U.S. Cl. 707/5; 707/E17.108

(57) ABSTRACT

A method, system and computer program product for searching for a venue based on a similarity value is disclosed. In one embodiment, the method includes receiving one or more selected attributes. The method further includes receiving one or more attribute-specific optional factor values and one or more venue-specific optional factor values. The method further includes searching a database containing a plurality of venue records each having one or more attributes and identifying the venue records having one or more attribute matches, the attribute matches being the selected attributes. The method further includes generating an attribute-specific similarity value and a venue-specific similarity value, and a total similarity value.

### TECHNICAL FIELD

The invention relates generally to search services and, more particularly, the invention relates to a system and method for searching for venues based on similarity values.

### BACKGROUND OF THE INVENTION

Current online search services for venues generally do not provide relevant matches. If a user wants to search for a venue, e.g., a restaurant, club, or bar, in a specified area, most search services provide the user with a list of all registered venues in the area. The user must call the various venues to determine if the restaurant, for example, offers the desired cuisine within a desired price range and other criteria.

Some search services allow the user to search for a venue based on one or more user selected attributes or qualifiers. For example, some search services allow the user to search for a restaurant by specifying one or more attributes, e.g., location, cuisine-type, price range. The search service then polls a database of restaurants in the area offering the cuisine-type and the price range. The search services provide one or more matches if they meet all of the user specified attributes. If there are no restaurants that meet all of the user specified attributes, the search services will not provide any match. Other existing search services do not allow the user to input a detailed search query because of a lack of searchable data base.

Consequently, users are often dissatisfied with results provided by most search services. Accordingly, there is a need for a system and method that provides a solution to the foregoing problems.

### SUMMARY

A method, system and computer program product for searching for a venue based on a similarity value is disclosed. In one embodiment, the method includes receiving one or more selected attributes. The method further includes receiving one or more attribute-specific optional factor values and one or more venue-specific optional factor values. The method further includes searching a database containing a plurality of venue records each having one or more attributes and identifying the venue records having one or more attribute matches, the attribute matches being the selected attributes.

The method further includes applying the attribute-specific optional factor values to the attribute matches to weight the attribute matches with the attribute-specific optional factor values. The method further includes summing the attribute matches weighted by the attribute-specific optional factor values to generate an attribute-specific similarity value. The method further includes applying the venue-specific optional factor values to the attribute matches to weight the attribute matches with the venue-specific optional factor values. The method further includes summing the attribute matches weighted by the venue-specific optional factor values to generate a venue-specific similarity value.

The method further includes applying a first predetermined weight to the attribute-specific similarity value and a second predetermined weight to the venue-specific similarity value to generate weighted first and second values, respectively. The method further includes summing the weighted first and second values to generate the total similarity value. The method further includes computing the total similarity values of a plurality of venues and listing one or more venues based on their respective total similarity values. In one example embodiment, the similarity value is computed relative to a specified venue submitted by a user. Thus, instead of providing the selected attributes, the user may enter an ID of a specified venue that is mapped to a plurality of attributes.

### BRIEF DESCRIPTION OF THE DRAWINGS

FIG. 1 is a flow diagram of a method for searching a venue based on a similarity value in accordance with one example embodiment.

FIG. 2 is a detailed flow diagram of a method for determining a similarity value of a venue in accordance with one example embodiment.

FIG. 3 is a flow diagram of a method for determining a similarity value in accordance with another example embodiment.

FIG. 4 is a system for searching a venue in accordance with one example embodiment.

FIG. 5 is a flow diagram of searching for similar venues based on a user specified venue from the user's perspective in accordance with one example embodiment.

FIG. 6 is a flow diagram of searching for venues based on a user specified venue from the system's perspective in accordance with one example embodiment.

### DETAILED DESCRIPTION OF THE INVENTION

In one example embodiment, a search system is provided for searching a venue directory listing a plurality of venues based on a similarity value (also referred to as a similarity score). The similarity value or score is computed relative to venue records submitted by the user. In one example embodiment, the similarity value or score is computed relative to a specified venue submitted by the user. The venue records are mapped to attribute sets. The venues may be restaurants, bars, clubs, coffee shops or other establishments. The venue directory is searched according to a predefined set of rules. More specifically, the venue directory is searched using one or more attributes or qualifiers. An attribute match in a venue is weighted by a combination of optional factors. In one example implementation, the optional factors include, but are not limited to, Importance factor, Uniqueness factor, Shared Subsets factor, and Prominence factor. The similarity value of the venue is computed from the sum of the attribute matches weighted by the optional factors.

In one example embodiment, the search system may be implemented in a computer system running an application to provide search capabilities, in the form of a search engine, to enable users to search for relevant venues. The search engine may search a data store, e.g., a database, having a venue directory listing information related to venues to provide venue data to a user.

In an illustrative implementation, the search system may be deployed on an Internet web site that offers venue listing information. Also, the search system may be deployed on an online social networking site having a plurality of users or members. By offering the search system, the social networking site enables users to conveniently search for venues based on a similarity value and to plan events, meetings, and gatherings.

In an illustrative implementation, the search system may comprise a user interface to enter search query information including one or more user selected attributes or qualifiers and a data store that houses a venue directory listing information related to venues. In one example embodiment, the user may enter or submit a specified venue instead of the attributes or qualifiers. The specified venue is mapped to attribute sets. The venue directory may list the venue information according to a predefined data classification. The user may access the search system via the Internet using a computing device such as a personal computer, a lap-top computer, a smart phone or a wireless device. The search system may comprise a means for displaying the search results. In operation, the search engine polls the data store according to a predefined set of rules and instructions for the relevant venue information.

In one example embodiment, the data store includes a plurality of venue records, each venue record having one or more attributes. The terms “data store” and “data base” are used interchangeably, and the terms “venue records” and “venue(s)” are used interchangeably herein. The term “specified venue” means the venue the user is trying to find similar venues to. In other words, the user enters or submits the “specified venue” and the search engine finds other venues that are similar to the “specified venue.”

The attributes may be, but are not limited to, the following:

(1) venue-type: restaurant, bar, club, coffee-shop, etc.

(2) cuisine-type: Italian. Mexican, French, Bar-B-Cue, etc.

(3) features: karaoke machine, juke box, pool table, etc.

(4) atmosphere: fine dining, casual, fast food, ambiance, etc.

(5) payment method: cash-only, credit cards, etc.

(6) specials: happy hour, events, etc.

(7) price range: inexpensive, moderate, expensive, etc.

(8) size of venue: small, large, medium, etc.

(9) parking: street parking, self parking, valet, etc.

(10) operating hours

(11) customer rating: 1, 2, 3, 4, 5 etc.

(12) distance: maximum distance of venue from user

(13) page views

(14) fan counts

(15) profile (messages posted, plans made, etc. by users or venue representative)

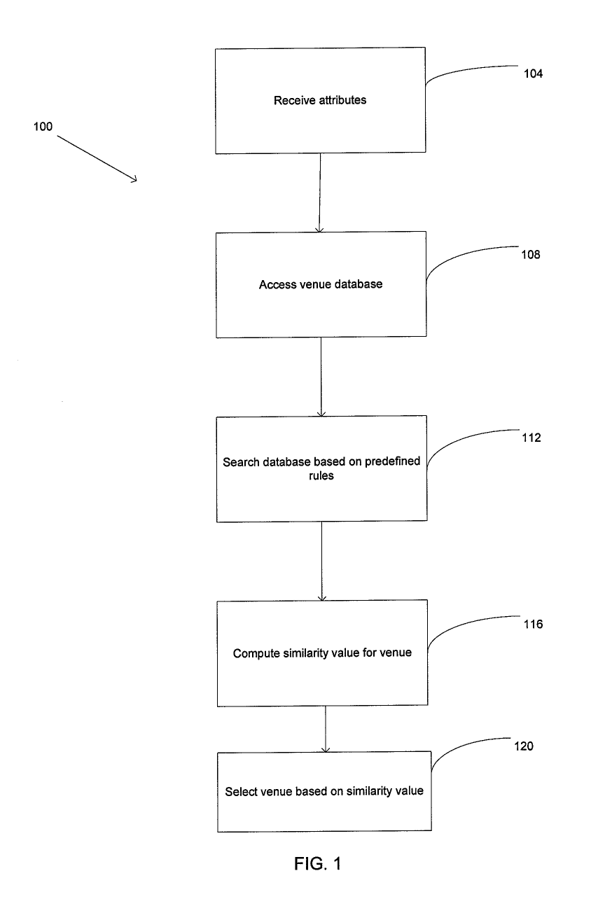

FIG. 1 is a flow diagram 100 of a method for searching a venue based on a similarity value in accordance with one example embodiment. In step 104, search attributes are received from a user. The attributes may be one or more attributes listed above or may be other attributes. In step 108, the database is accessed. In step 112, the database is polled and predefined rules are applied on the records of the database. In step 116, a similarity value is computed for each venue. In step 120, one or more venues are selected based on the similarity values.

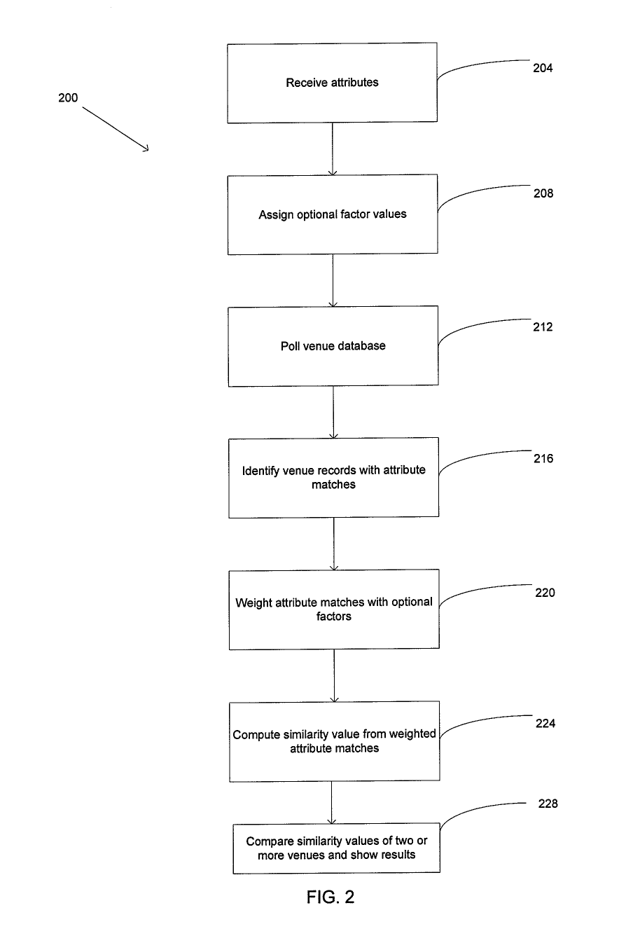

FIG. 2 is a detailed flow diagram 200 of a method for computing the similarity value of a venue in accordance with one example embodiment. In step 204, one or more attributes selected by the user are received. The user may select the attributes from a plurality of attributes displayed on an Internet web site that offers venue listing information. The attributes may be one or more attributes listed above or may be other attributes. As discussed before, in one example embodiment, the user may submit or enter a specified venue (or an ID representing the specified venue). The specified venue (or the ID) is mapped to attributes. Thus, instead of selecting the attributes, the user may simply submit a specified venue (or an ID of the specified venue) which is mapped to attributes.

In step 208, the optional factor values for attribute matches are assigned. The optional factor values for the attribute matches may be assigned by the user. Alternatively, the optional factor values may be assigned by the system based on the user's profile, the user's preferences, or prior search results. The optional factor values may be stored in the system under the user's profile or in some other manner.

As noted before, in one example implementation, the optional factors include, but are not limited to, Importance factor, Uniqueness factor, Shared Subsets factor, and Prominence factor. In addition, if enabled by the user or the system, an optional Preference factor can be added to tailor the similarity computation to a user's perception.

The optional factors are either attribute-specific or venue-specific. An attribute-specific optional factor applies to each attribute individually and is independent of any venue or attribute set association. A venue-specific optional factor applies to each venue individually, and is dependent on the particular venue or the particular venue's attribute set association (e.g., each venue only has one Shared Subsets factor, which is relative to a Specified Venue).

The optional factors are considered optional because they are used to primarily optimize the search results. Instead of using a binary matching system, the optional factors are used to optimize the attribute matches in order to generate highly relevant and superior matches. The optional factors are briefly discussed below.

The optional Importance factor is used to specify the relative importance of an attribute among a set of attributes. The Importance factor is venue-independent, but attribute-specific. The Importance factor can be assigned by the user, by database analysis or can be deduced systematically based on user trends.

The optional Uniqueness factor is a measure of uniqueness of a particular attribute relative to other attributes. The Uniqueness factor is venue-independent, but attribute-specific. For example, 5,000 venues may exist in a database, but only 500 of those venues may offer the “Karaoke” attribute. Accordingly, in one example implementation the “Karaoke” attribute may be weighted by a Uniqueness factor=[1-500/(# of venues)]; or [1−500/5000]; or 0.9.

The optional Prominence factor indicates how much of an attribute a venue has. The Prominence factor is venue-specific and attribute-specific. For example, using a scale of 1-10, a first steakhouse specializing in steaks might have a Prominence factor of 10 for the attribute “steaks.” A second restaurant might have a Prominence factor of 2 because the second restaurant offers some steaks but does not specialize in steaks. In one example implementation, a formula may be applied to calculate the Prominence Factor difference, yielding a percentage match such as 20%.

The optional Shared Subsets factor is used for venue to venue comparison. The Shared Subsets factor is venue-specific, relative to the Specified Venue. The magnitude of the Shared Subsets of attributes can be determined and weighted appropriately based on factors such as subset size, frequency within the database, and relative Importance of attributes contained within the subset. For example, when Venue A is compared to the Specified Venue, there may be several shared or “overlapping” subsets of attributes. Both may be mapped to some of the same subsets of attributes, such as S1: {Jukebox, TV, Darts} and S2: {Dancing, Sushi}. Subsets are first weighted individually. Although S1 is greater in size, it may be more common within the database, and its attributes may not be as substantial (i.e.,: Importance factor). Therefore, S2 may have greater magnitude. In one example embodiment, a formula is applied to the greatest magnitude, to determine an appropriate weight based on the maximum Shared Subsets magnitude possible within the database. In another example embodiment, a combined subset magnitude approach is used, which factors in more than one shared subset magnitude.

The optional Preference factor indicates a user's interest, preference or dislike for a particular attribute. The Preference factor can be explicitly specified by the user or may be deduced implicitly. The Preference factor is venue-independent, but attribute-specific. For example, using a scale of 1-10, a user may be associated with the following preferences: {Chocolate: 9}, {Beer: 2}, {Pool Table: 6}, {Lamb: 10}, {Coffee: 7}, etc. A formula is then applied to attribute matches between Venue A and the Specified Venue, which assigns a score to each attribute match based on the (1-10) user preference value, as well as factors like attribute Prominence and Importance. The attribute match scores are then combined and scaled appropriately based on the maximum attainable attribute match score.

In step 212, a database containing one or more venue records is polled. In step 216, one or more venue records containing at least one of the user-selected attributes (i.e., attribute matches) are identified. For example, the search may identify 20 venues each containing at least one attribute match. Of the 20 identified venues, for example, there may be 5 venues that contain all the attribute matches and there may be 15 venues that each contains at least one of the attribute matches.

In step 220, the attribute matches in the identified venue records are weighted with the optional factors. As discussed before, each attribute match is weighted by an optional Importance factor, an optional Uniqueness factor, an optional Prominence factor, and an optional Shared Subsets factor. Additionally, if enabled by the user or the system, the attribute match may be weighted by the optional Preference factor.

For example, if A1 is an attribute match, then A1 is weighted as follows:

{(A1×IF)+(A1×UF)+(A1×PF)} (1),

where IF is the Importance factor, UF is the Uniqueness factor, and PF is the Prominence factor.

In step 224, the similarity value for a particular identified venue is computed from the weighted attribute matches. For example, if a particular identified venue record includes the following attribute matches A1, A2, A3, then the similarity value SV for that particular venue record is shown below, where SF is the Shared Subsets factor.

SV=[({)A1×IF)+(A1×UF)+(A1×PF)}+{(A2×IF)+(A2×UF)+(A2×PF)}+{(A3×IF)+(A3×UF)+(A3×PF)}] . . . +[SF] (2)

In step 228, the similarity values of two or more venues are compared and the result is presented to the user. In one example implementation, one or more venues receiving the top similarity values are presented to the user.

In one example implementation, the similarity value of a venue can be calculated based only on attribute-specific factors. Thus, the similarity value based only on attribute-specific factors is shown below.

SV=[{(A1×IF)+(A1×UF)+(A1×PF)}+{(A2×IF)+(A2×UF)+(A2×PF)}+{(A3×IF)+(A3×UF)+(A3×PF)}] (3)

Note that in (3) above, the Shared Subsets factor SF has been removed from the computation of the similarity value because SF is venue-specific. In one implementation, each optional attribute-specific factor may itself be weighted based on predetermined criteria before being combined for each attribute match.

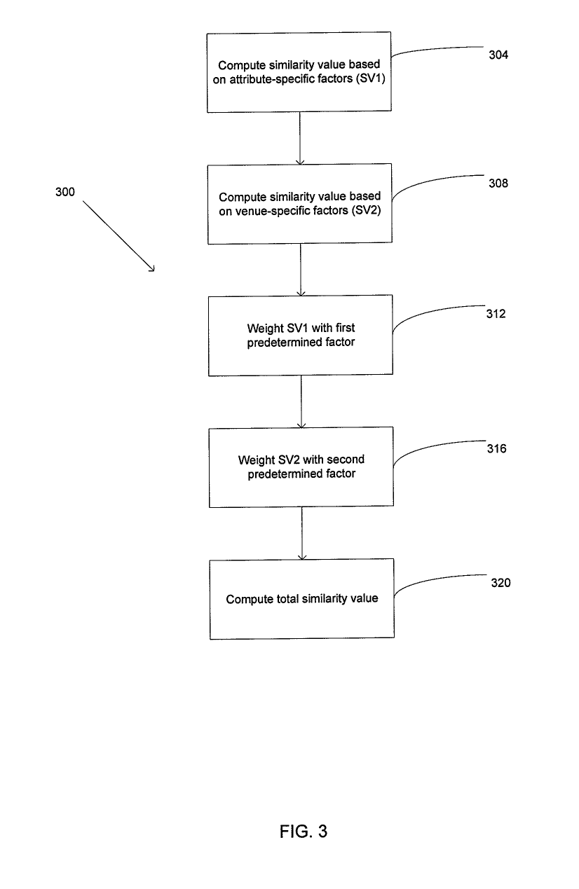

In one example implementation, similarity values based on the attribute-specific factors and the venue-specific factors are separately computed. The similarity value based on the attribute-specific factor is weighted by a first predetermined factor, and the similarity value based on the venue-specific factor is weighted by a second predetermined factor. Finally, the two similarity values are added to generate the final similarity value for a particular venue. FIG. 3 is a flow diagram 300 of this implementation. In step 304, the similarity value based on attribute-specific factors (SV1) is computed. In step 308, the similarity value based on the venue-specific factors (SV2) is computed. In step 312, SV1 is weighted by a first predetermined factor. In step 316, SV2 is weighted by a second predetermined factor. In step 320, the total similarity value SVtotal is computed by adding the weighted SV1 and the weighted SV2.

For example, if SV1 is the similarity value based on attribute-specific factors and SV2 is the similarity value based on venue-specific factors, then the total similarity value SVtotal is provided below.

SVtotal={F1×SV1+F2×SV2} (4),

where F1 and F2 are first and second predetermined factors, respectively.

In one example embodiment, a database is created containing a plurality of venue records. The venue records can be searched based on the rules discussed above.

In one example embodiment, additional user-input driven optional factors such as Quality factor and Venue Rating factor may be used in the similarity value computation. The user-input driven optional factors may be considered once users start rating venues and attributes. Subsets of these ratings can be used to calculate factors. For example the Quality factor may be calculated based on the quality ratings left by the users of the venue or site or by the friends of the user, or by some other combination. The Venue rating may likewise be calculated.

The Quality factor is a venue-specific, attribute-specific optional factor. The Quality factor corresponds to “how good” an attribute of a venue is. For example, using a scale of 1-10, a generic steakhouse might have a quality rating of 6 for the “Steaks” attribute, whereas a gourmet steakhouse might have a quality rating of 10, because the steaks available at the gourmet steakhouse are of superior quality. A formula may be applied to calculate the Quality factor based on the quality rating difference, yielding a percentage match such as 60%.

The Venue Rating factor is a venue-specific, attribute-independent optional factor. The Venue Rating factor corresponds to a user's overall perception/rating of a venue. For example, using a scale of 1-10, a user or set of users may leave a venue rating of 10 for Coffeehouse A, and a venue rating of 10 for Ice Cream Shoppe B. When compared to Venue C, which has a venue rating of 8, a formula may be applied to calculate the Venue Rating weight based on the venue rating difference, yielding a percentage match such as 80% for both Coffeehouse A and Ice Cream Shoppe B.

In one example implementation the Importance factor and other factors may be varied or adjusted by location (user trends in each area). For instance, the Importance factor may vary with the time of year, temperature conditions, and other factors which may eventually show up in local trends. Thus, in the spring, the Importance factor for “ice cream” in some cities in California may be increased due to (past/present) user trends and rising temperatures, while the Importance factor for “ice cream” in Michigan may remain relatively unchanged, and the Importance factor for “hot cider” may instead be higher.

In one example implementation, external indicators may be used to help predict user trends at certain times (or days) of year and adjust attribute weighting factors accordingly (versus waiting for users to show a trend) which may promote more unexpected (yet relevant) results for the user.

In one example embodiment, one or more venues based on their respective similarity values are displayed on a map. The map may display the address and street location of the venue, thus providing the exact location of the venue. One or more photos (e.g., a panoramic view) of the listed venues can also be displayed on the map, thus providing the user with the address, location on the map and the photos of the venue.

In one example embodiment, the venues are displayed on a map accompanied by their addresses and driving directions to the venues. Various commercially available navigation systems may be utilized to provide the driving directions to the venues.

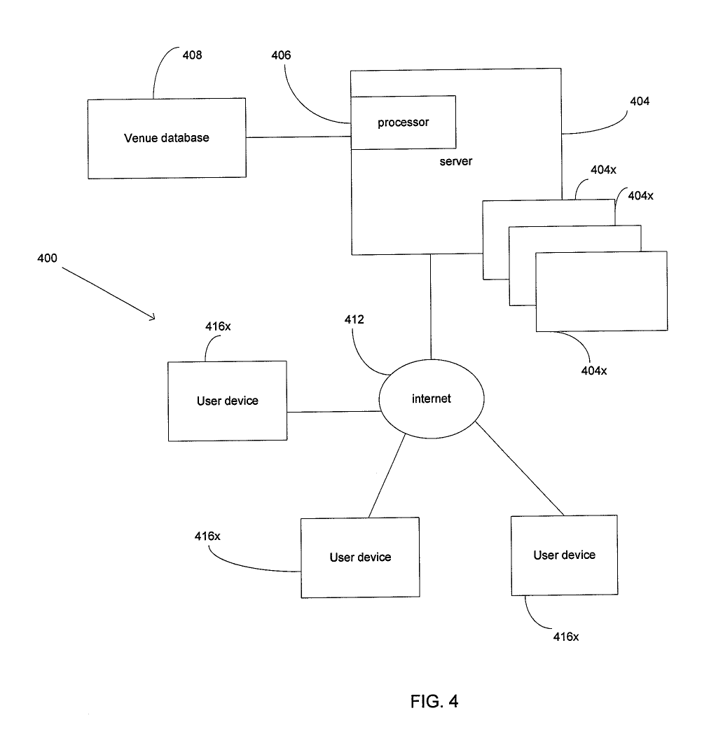

FIG. 4 is system 400 for searching a venue in accordance with one example embodiment. The system 400 may be deployed on an Internet web site that offers venue listing information. Also, the system 400 may be deployed on an online social networking site having a plurality of users.

The system 400 includes a server 404 having a processor 406. The server 404 is connected to a data store such as a database 408. The database 408 includes a plurality of venue records each having one or more attributes. Responsive to one or more user selected attributes, the processor 406 polls the venue records in the database 408 for one or more venues and provides a result having one or more identified or listed venues. The server 404 is connected to a plurality of user devices 416x via the Internet 412. The user device 416x may be a personal computer, a lap-top computer, a PDA, a smart phone or any other computing device. A user may use the user device 416x connect with the server 404 via the Internet. The server 404 is configured to serve one or more web pages 404x to the user devices 416x. The user devices 416x use the web pages 404x to input search queries having one or more attributes, weight factors and other information. The system 400 also provides the search result on one or more web pages 404x.

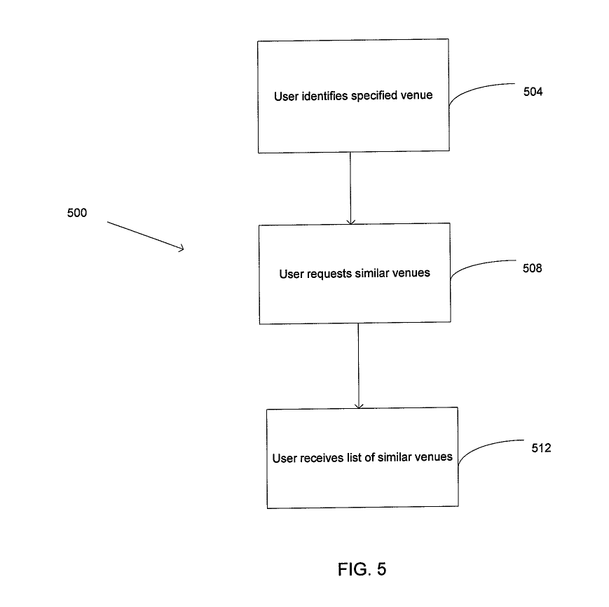

FIG. 5 is a flow diagram 500 of searching for similar venues based on a user identified “specified venue” from the user's perspective in accordance with one example embodiment. In step 504, the user identifies a specified venue (e.g., Venue X) instead of explicitly specifying a set of attributes. Venue X is mapped to a set of attributes stored by the system. In step 508, the user requests similar venues to Venue X. For example the user may click on a “find similar venues” button. The user may optionally specify a location such as a particular city and state. In step 512, the user receives a list of venues similar to Venue X. The list of venues is generated based on a similarity score calculated relative to Venue X, and may be filtered by location, operating hours, or other specified factors. The calculation of the similarity score has been described above. The list of venues may be ordered by similarity score or other factors.

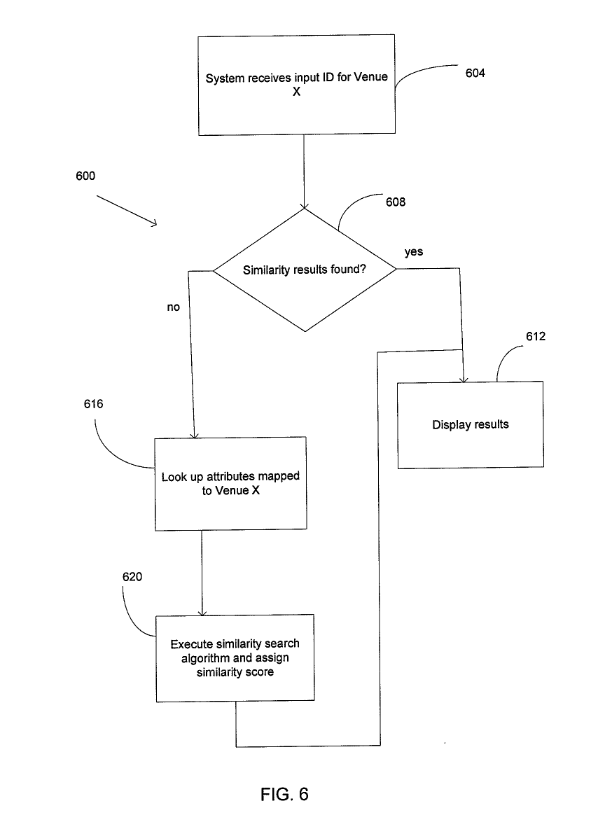

FIG. 6 is a flow diagram 600 of searching for venues based on a user specified venue from the system's perspective. In step 604, the system receives an input ID corresponding to the specified venue (e.g., Venue X). In step 608, the system searches for similarity results in a cache. If similarity results are found in the cache, in step 612 the system displays results (e.g., results ordered by similarity score). If in step 608, the similarity results are not found in the cache, the flow moves to step 616 where the system looks up attributes mapped to Venue X and other data required for similarity calculations (e.g., weight factors) as well as any required user-specified data such as Preferences. In step 620, the system executes the similarity search algorithm (discussed before) and assigns similarity scores to venue results. The search results are then displayed in step 612 (e.g., ordered by similarity score).

In one example embodiment, a computer program product having a computer readable medium embodies a plurality of computer readable codes for executing the method steps described in the foregoing for searching venues.

The system, method, computer program product may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the implementations of the present invention is as a routine in an operating system made up of programming steps or instructions resident in a memory of a computing system as well known, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, and the like. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a general purpose digital computer, software applications, routines and software modules, hardware including application specific integrated circuits, programmable logic devices, field programmable gate arrays, optical and other mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A method for searching for a venue based on a similarity value, comprising:
receiving one or more selected attributes;
receiving one or more optional factor values;
searching a database containing a plurality of venue records each having one or more attributes;
identifying the venue records having one or more attribute matches, the attribute matches being the selected attributes;
applying the optional factor values to the attribute matches to weight the attribute matches;
determining the similarity value of the venue records based on the sum of the weighted attribute matches of each venue;
listing at least one of the venue records based on the similarity value.

2. The method of claim 1, wherein the optional factors are attribute-specific optional factors.

3. The method of claim 1, wherein the optional factors are venue-specific optional factors.

4. The method of claim 1, wherein the application of the optional factor values and determination of the similarity values further comprise:
applying attribute-specific optional factor values to the attribute matches to weight the attribute matches with the attribute-specific optional factor values;
summing the attribute matches weighted by the attribute-specific optional factor values to generate an attribute-specific similarity value;
applying venue-specific optional factor values to the attribute matches to weight the attribute matches with the venue-specific optional factor values;
summing the attribute matches weighted by the venue-specific optional factor values to generate a venue-specific similarity value;
applying a first predetermined weight to the attribute-specific similarity value and a second predetermined weight to the venue-specific similarity value to generate weighted first and second values, respectively;
summing the weighted first and second values to generate the total similarity value.

5. The method of claim 1, wherein the optional factor values include an Importance factor representing the importance of a particular attribute relative to other attributes.

6. The method of claim 1, wherein the optional factor values include a Uniqueness factor representing the uniqueness of a particular attribute relative to other attributes.

7. The method of claim 1, wherein the optional factor values include a Prominence factor representing how much of an attribute a venue has.

8. The method of claim 1, wherein the optional factor values include a Shared Subsets factor representing the uniqueness of Shared Subsets of attributes among venues.

9. The method of claim 1, wherein the optional factor values include a Preference factor representing a user's preference for a particular attribute.

10. The method of claim 1, wherein the selected attributes are related to a specified venue, the specified venue being mapped to the selected attributes.

11. The method of claim 1, wherein the selected attributes are related to an identification (ID) of a specified venue, the ID being mapped to the selected attributes.

12. A method for searching for a venue based on a similarity value, comprising:
receiving one or more selected attributes;
receiving one or more attribute-specific optional factor values;
receiving one or more venue-specific optional factor values;
searching a database containing a plurality of venue records each having one or more attributes;
identifying the venue records having one or more attribute matches, the attribute matches being the selected attributes;
applying the attribute-specific optional factor values to the attribute matches to weight the attribute matches with the attribute-specific optional factor values;
summing the attribute matches weighted by the attribute-specific optional factor values to generate an attribute-specific similarity value;
applying the venue-specific optional factor values to the attribute matches to weight the attribute matches with the venue-specific optional factor values;
summing the attribute matches weighted by the venue-specific optional factor values to generate a venue-specific similarity value;
applying a first predetermined weight to the attribute-specific similarity value and a second predetermined weight to the venue-specific similarity value to generate weighted first and second values, respectively;
summing the weighted first and second values to generate the total similarity value.

13. The method of claim 12, further comprising computing the total similarity values of a plurality of venues.

14. The method of claim 12, further comprising listing one or more venues based on their respective total similarity values.

15. The method of claim 12, wherein the attribute-specific optional factor values include an Importance factor representing the importance of a particular attribute relative to other attributes.

16. The method of claim 12, wherein the attribute-specific optional factor values include a Uniqueness factor representing the uniqueness of a particular attribute relative to other attributes.

17. The method of claim 12, wherein the attribute-specific optional factor values include a Prominence factor representing how much of the attribute the venue has.

18. The method of claim 12, wherein the venue-specific optional factor values include a Shared Subsets factor representing the uniqueness of Shared Subsets of attributes among venues.

19. The method of claim 12, wherein the attribute-specific optional factor values include a Preference factor representing a user's preference for a particular attribute.

20. The method of claim 12, wherein the selected attributes are related to a user specified venue, the user specified venue being mapped to the selected attributes.

21. In an online social network having a plurality of users connected through the Internet, a computer-implemented method for searching for a venue based on a similarity value, comprising:
receiving one or more selected attributes;
receiving one or more attribute-specific optional factor values;
receiving one or more venue-specific optional factor values;
searching a database containing a plurality of venue records each having one or more attributes;
identifying the venue records having one or more attribute matches, the attribute matches being the selected attributes;
applying the attribute-specific optional factor values to the attribute matches to weight the attribute matches with the attribute-specific optional factor values;
summing the attribute matches weighted by the attribute-specific optional factor values to generate an attribute-specific similarity value;
applying the venue-specific optional factor values to the attribute matches to weight the attribute matches with the venue-specific optional factor values;
summing the attribute matches weighted by the venue-specific optional factor values to generate a venue-specific similarity value;
applying a first predetermined weight to the attribute-specific similarity value and a second predetermined weight to the venue-specific similarity value to generate weighted first and second values, respectively;
summing the weighted first and second values to generate the total similarity value.

22. The computer-implemented method of claim 21, further comprising computing the total similarity values of a plurality of venues.

23. The computer-implemented method of claim 21, further comprising listing one or more venues based on their respective total similarity values.

24. A computer-implemented system for searching for a venue based on a similarity value, the system being linked to a plurality of users by the Internet, comprising:
a processor configured to receive a plurality of user inputs;
a database connected to the processor, the database containing a plurality of venue records each having one or more attributes, the database responsive to the processor to provide data to the processor;
the processor configured to execute a plurality of steps comprising:
receiving one or more selected attributes;
receiving one or more optional factor values;
searching a database containing a plurality of venue records each having one or more attributes;
identifying the venue records having one or more attribute matches, the attribute matches being the selected attributes;
applying the optional factor values to the attribute matches to weight the attribute matches;
determining the similarity value of the venue records based on the sum of the weighted attribute matches of each venue;
listing at least one of the venue records based on the similarity value.

25. A method for searching for a venue based on a similarity value, comprising:
receiving an identification (ID) for a specified venue, the specified venue being mapped to first attributes;
receiving one or more optional factor values;
searching a database containing a plurality of venue records;
identifying the venue records having one or more attribute matches, the attribute matches being the first attributes;
applying the optional factor values to the attribute matches to weight the attribute matches;
determining the similarity value of the venue records based on the sum of the weighted attribute matches of each venue;
listing at least one of the venue records based on the similarity value.
